(19) United States
(12) Patent Application Publication
(10) Pub. No.: US 2017/0048733 A1
(43) Pub. Date: Feb. 16, 2017

(54) MINIMUM MEASUREMENT REQUIREMENTS FOR MULTI-BROADCAST SINGLE-FREQUENCY NETWORK MEASUREMENTS

(71) Applicant: Nokia Technologies Oy, Espoo (FI)

(72) Inventors: Lars Dalsgaard, Oulu (FI); Ilkka Keskitalo, Oulu (FI)

(73) Assignee: Nokia Technologies Oy, Espoo (FI)

(21) Appl. No.: 15/306,440

(22) PCT Filed: May 6, 2015
(86) PCT No.: PCT/FI2015/050306

§ 371 Date: Oct. 24, 2016

Related U.S. Application Data
(60) Provisional application No. 61/990,993, filed on May 9, 2014.

(51) Int. Cl. H04W 24/08; H04W 24/02; H04W 76/04; H04W 72/00

(52) U.S. Cl. CPC H04W 24/08; H04W 72/005; H04W 24/02; H04W 76/048; H04W 88/02

(57) ABSTRACT

Various communication systems may benefit from well-defined measurement requirements. For example, measurements for multi-broadcast single-frequency networks (MBSFNs) may benefit from definition of minimum measurement requirements related to, for example, reference signal received power (RSRP) and reference signal received quality (RSRQ). A method may include obtaining MBMS configuration parameters. The method may also include defining generic minimum MBSFN measurement performance requirements, based on the MBMS configuration parameters.

### CROSS-REFERENCE TO RELATED APPLICATION

This application is related to and claims the benefit and priority of U.S. Provisional Patent Application No. 61/990,993, filed May 9, 2014, the entirety of which is hereby incorporated herein by reference.

### BACKGROUND

Field

Various communication systems may benefit from well-defined measurement requirements. For example, measurements for multi-broadcast single-frequency networks (MBSFNs) may benefit from definition of minimum measurement requirements related to, for example, reference signal received power (RSRP) and reference signal received quality (RSRQ).

Description of the Related Art

Third generation partnership project (3GPP) R1-135918, which is hereby incorporated herein by reference in its entirety, has defined MBSFN measurements. R1-135918 introduces MBSFN RSRP and MBSFN RSRQ as well as MBSFN block error rate (BLER). There are not, however, fully defined minimum requirements for these newly defined MBSFN measurements. For example, requirements related to user equipment (UE) performance when performing such measurements are not defined.

MBSFN measurements themselves are different from minimum performance requirements for MBSFN measurement. There is no definition of how to map, for example, physical multicast channel (PMCH) decoding requirements to minimum MBSFN measurement requirements in R1-135918. For example, R1-135918 states that the measurement is made only in subframes and on carriers where the UE is decoding PMCH.

### SUMMARY

According to a first embodiment, a method may include obtaining MBMS configuration parameters. The method may also include defining generic minimum MBSFN measurement performance requirements, based on the MBMS configuration parameters.

In a variant, definition of the generic minimum MBSFN measurement performance requirements may be further based on rules for monitoring the MBMS MCCH.

In a variant, the definition is based on a change notification repetition period, wherein the change notification repetition period may be equal to a shortest modification period divided by a notification repetition coefficient.

In a variant, definition of generic minimum MBSFN measurement performance requirements may be split with respect to whether receiving MBMS data or not receiving MBMS data.

In a variant, when receiving MBMS data, the generic minimum MBSFN measurement performance requirements may be based on a configured MCCH reception period.

In a variant, when not receiving MBMS data, the generic minimum MBSFN measurement performance requirements may be based on an MCCH change notification repetition period. The change notification repetition period may be equal to a shortest modification period divided by a notification repetition coefficient.

In a variant, definition of the generic minimum MBSFN measurement performance requirements may include deriving which minimum requirements are to be applied according to discontinuous reception measurement requirements.

Each of the above variants may be used in combination with one another.

According to a second embodiment, an apparatus may include at least one processor and at least one memory including computer program code. The at least one memory and the computer program code may be configured to, with the at least one processor, cause the apparatus at least to obtain MBMS configuration parameters. The at least one memory and the computer program code may also be configured to, with the at least one processor, cause the apparatus at least to define generic minimum MBSFN measurement performance requirements, based on the MBMS configuration parameters.

The second embodiment may include any of the variants of the first embodiment individually or in any combination.

According to a third embodiment, an apparatus may include means for obtaining MBMS configuration parameters. The method may also include means for defining generic minimum MBSFN measurement performance requirements, based on the MBMS configuration parameters.

The third embodiment may include any means for carrying out the variants of the first embodiment individually or in any combination.

According to a fourth embodiment, a non-transitory computer readable medium may be encoded with instructions that, when executed in hardware, perform a process. The process may be the method according to the first embodiment, in any of its variants or combinations thereof.

According to a fifth embodiment, a computer program product may encode instructions for performing a process. The process may be the method according to the first embodiment, in any of its variants or combinations thereof.

### BRIEF DESCRIPTION OF THE DRAWINGS

For proper understanding of the invention, reference should be made to the accompanying drawings, wherein:

FIG. 1 illustrates modification periods.

FIG. 2 illustrates parameters in an MBMS-NotificationConfig information element (IE).

FIG. 3 illustrates an MBSFN-AreaInfoList IE.

FIG. 4 illustrates a method according to certain embodiments.

FIG. 5 illustrates a system according to certain embodiments.

### DETAILED DESCRIPTION

The requirements related to multi-broadcast single-frequency network (MBSFN) measurements may need to be done in the same spirit as other measurements performed by the user equipment (UE). For example, the measurements may need to be done when the UE is otherwise required to have its receiver open, for example due to reception, and it may be beneficial for the UE not to be required to wake up its receiver for the sole purpose of performing measurements. Examples include idle and connected mode measurements when idle and connected mode discontinuous reception (DRX) is applied. In these cases the measurement requirements may be adjusted/aligned/relaxed when DRX is used/applied as compared to when DRX is not applied.

In a similar manner there may be a need to ensure that MBSFN measurement requirements are tied to the UE multimedia broadcast multicast service (MBMS) monitoring requirements. Using existing point-to-point (p2p) measurement requirements as such may not be possible, as the MBMS is not a p2p service but is based on broadcast, in which multiple UEs receives same broadcast information. The broadcast information may be transmitted independently from p2p data or information and therefore the requirements originating or related to p2p transmissions may not be able to be reused for MBMS requirements.

Certain embodiments, by contrast, provide a clear mapping between the MBMS monitoring requirements and the UE minimum MBSFN measurements performance requirements. Thus, certain embodiments provide techniques that tie the MBMS configuration with the minimum measurements requirements.

3GGP technical specification (TS) 36.331 specifies requirements related to what a UE is required to monitor if the UE is receiving or interested in receiving one or more MBMS sessions. These monitoring requirements depend on the network MBMS configuration. It is proposed to use these monitoring requirements as baseline or input for defining the minimum MBSFN measurement performance requirements.

Thus, the MBSFN measurements performance may be based on MBMS monitoring requirements that may depend on the network MBMS configuration. The network MBMS configuration may be used as input to a determination of the performance requirements for the MBSFN measurements in such a way that generic requirements are defined. These generic requirements may be linked to and depend directly on the MBMS configuration and the MBMS monitoring.

For MBMS, two channels may be used, both mapped to physical MBMS channel (PMCH). One channel may be an MBMS control channel (MCCH), which may carry MBSFN area configuration and counting requests. Another channel may be an MBMS traffic channel (MTCH), which may carry the MBMS user plane data and information, including scheduling information

MCCH may have a configured mcch-RepetitionPeriod and mcch-ModificationPeriod, and these values may be indicated in SIB13. There may be specific requirements for the UE to monitor MCCH for possible changes in the configuration information. The monitoring requirements may depend on the UE state regarding the MBMS service reception.

Thus, the MBSFN measurement requirements may be based on MBMS monitoring requirements and may not be a fixed scheme, for example a fixed measurement interval, nor p2p transmission.

In one example the MBSFN requirements may be defined based on a change notification repetition period as follows P_{cnr}=Pₛₘ/Cₙᵣ, where P_{cnr} is a change notification repetition period, Pₛₘ is a shortest modification period and Cₙᵣ is a notification repetition coefficient. More particular, the shortest modification period may be mcch-ModificationPeriod (rf512, rf1024), and the notification repetition coefficient, or notificationRepetitionCoeff, may be (2, 4). Thus, the following change notification repetition periods may result: [128; 256; 512; 1024].

These resultant change notification repetition periods, combined with the following possible requirement, may yield the UE minimum monitoring requirements. The possible additional requirement may be that a UE that is receiving an MBMS service is to acquire the MCCH information from the start of each modification period. This minimum MBMS MCCH monitoring requirement may then be used to develop the MBMS minimum measurement requirements.

In another example, the UE may calculate the change notification period as above and based on this change notification period may derive the minimum requirements that are to be applied according to existing DRX requirements, for example, as already defined for connected mode when DRX is applied.

The minimum MBSFN measurement requirements may be defined such that the UE is not required to measure MBMS reference symbol (RS), or otherwise perform MBSFN measurements, beyond what the UE may measure during active times, namely when receiver is on, due to other MBMS reception requirements. For example, the measurement requirements may be based on measurement opportunities available due to receiving the MBMS information of interest, such as the actual MBMS reception. Thus, requirements may be linked to the actual reception of MBMS

As MBMS data reception may depend on which service(s) the UE has subscribed to, or is interested in receiving, the actual reception of MBMS data on MTCH may be, as any other data reception, rather unpredictable and for MBMS up to network scheduling. Therefore it may also be beneficial to define MBSFN measurement performance requirements based on a more frequently occurring event for the cases when the MBMS data reception is not ongoing. For this purpose the minimum MCCH monitoring requirements may be utilized. As an additional option, the PMCH carrying MBMS scheduling information (MSI) in the beginning of each MCH scheduling period, may be used as additional samples for when measuring MCCH. This is due to the fact that the modulation and coding schemes (MCS) of the MCCH and the first PMCH of the MCH scheduling period may be the same. Hence, all the control information may have equal performance with the same MCS. Also, the measurements may be done per MCS. Therefore MTCH measurements may exclude the first PMCH of the MCH scheduling period. The length of the MCH scheduling period, which is configured with the MCCH control information, may be 8, 16, 32, 64, 128, 256, 512 and 1024 radio frames. Shortest scheduling periods may provide more frequent measurement opportunities and hence improved measurement accuracy. The description below referring to MCCH monitoring may or may not include the reception of the first PMCH of the MCH scheduling period.

Using the MCCH reception/monitoring requirement may provide predictable, testable, and clearly defined requirements based on the MBMS configuration used in the network.

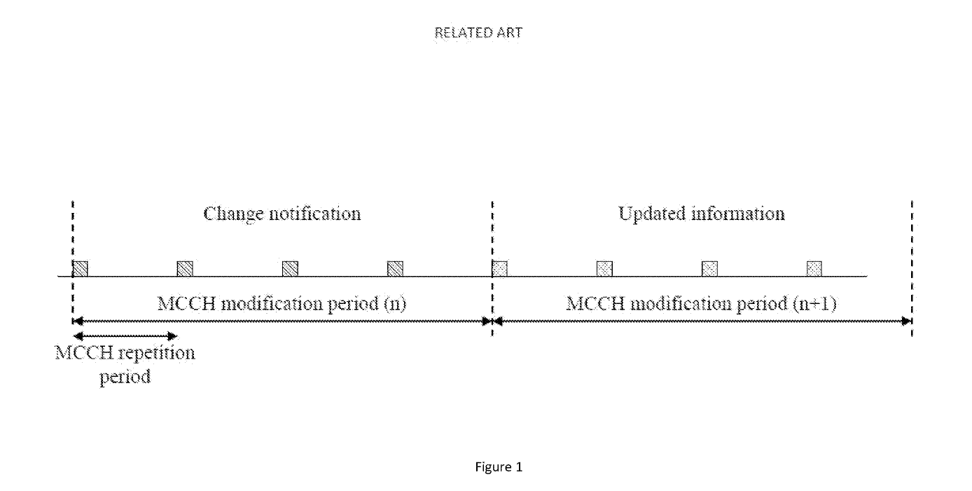

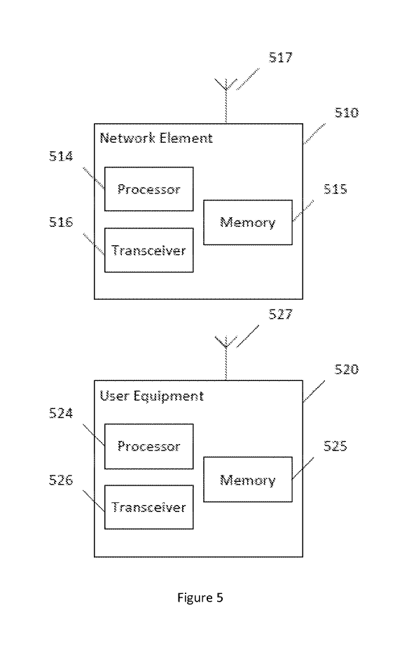

As described in 3GPP TS 36.331, when the network changes at least some of the MCCH information, it may notify the UEs about the change during a first modification period. In the next modification period, the network may transmit the updated MCCH information. FIG. 1 illustrates modification periods and is adapted from FIG. 5.8.1.3-1 of 36.331.

The UE may benefit from monitoring the notification independently of whether active reception is ongoing or not and may measure more if receiving.

In FIG. 1, the different textures indicate different MCCH information. Upon receiving a change notification, a UE interested to receive MBMS services may acquire the new MCCH information immediately from the start of the next modification period. The UE may apply the previously acquired MCCH information until the UE acquires new MCCH information.

The UE may benefit from monitoring change of MCCH information even when not actively receiving MBMS service. This approach may be used for developing the minimum MBSFN measurement requirements.

There may be a variety of possible change notification rules. The following extracts some possible rules that may be used for MCCH monitoring. The settings and parameters extracted used for MCCH monitoring may also be used for extracting the minimum performance requirements for MBSFN measurements.

Currently 3GPP TS 36.331 states that an indication of an MBMS specific RNTI, the M-RNTI described at 3GPP TS 36.321, on PDCCH may be used to inform UEs in RRC_IDLE and UEs in RRC_CONNECTED about an MCCH information change. No further details are provided, for example, regarding which MCCH information will change. Moreover, these MCCH information change notification occasions may be common for all MCCHs that are configured. These occasions may be configurable by parameters included in System Information Block (SIB) Type13 (SIB13). The parameters may include a repetition coefficient, a radio frame offset, and a subframe index. These common notification occasions may be based on the MCCH with the shortest modification period.

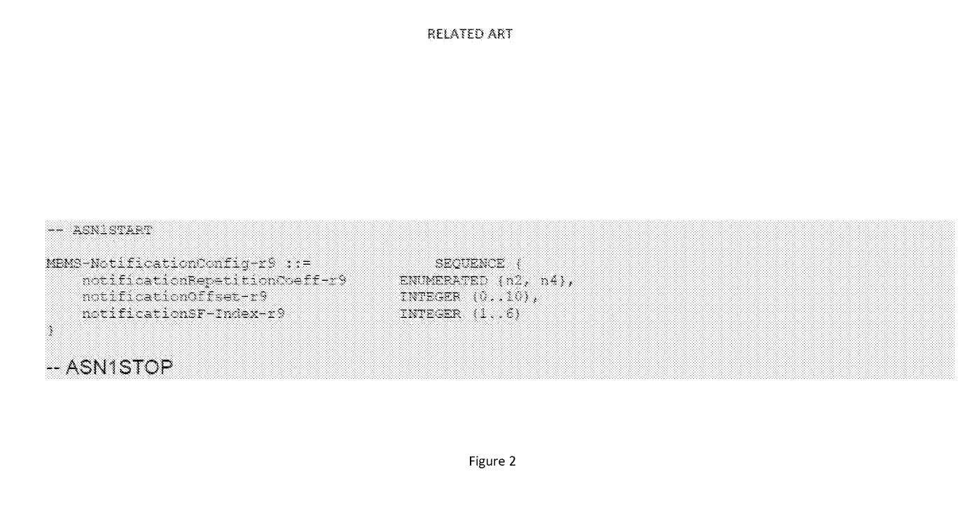

FIG. 2 illustrates parameters that are listed in SIB13 in an MBMS-NotificationConfig Information Element (IE). As shown in FIG. 2, the MBMS-NotificationConfig may indicate a notification repetition coefficient (notificationRepetitionCoeff), notification offset (notificationOffset), and notification subframe (notificationSF).

The field notificationOffset may indicate, together with the notificationRepetitionCoeff, the radio frames in which the MCCH information change notification is scheduled. For example the MCCH information change notification may be scheduled in radio frames for which SFN mod notification repetition period=notificationOffset.

The field notificationRepetitionCoeff may indicate an actual change notification repetition period common for all MCCHs that are configured, which may be the shortest modification period/notificationRepetitionCoeff. The shortest modification period may correspond to the lowest value of mcch-ModificationPeriod of all MCCHs that are configured. Value n2 may correspond to coefficient 2, and so on.

The field notificationSF-Index may indicate the subframe used to transmit MCCH change notifications on PDCCH. In frequency division duplex (FDD), value 1, 2, 3, 4, 5 and 6 may respectively correspond to subframe #1, #2, #3 #6, #7, and #8. Similarly, in time division duplex (TDD), value 1, 2, 3, 4, and 5 may respectively correspond to subframe #3, #4, #7, #8, and #9.

Based on the information in an MBMS-NotificationConfig IE, it may be possible to calculate the change notification repetition period as follows: P_{cnr}=Pₛₘ/Cₙᵣ, where P_{cnr} refers to a change notification repetition period, Pₛₘ refers to a shortest modification period, and Cₙᵣ refers to notificationRepetitionCoeff. The field notificationRepetitionCoeff having values (2, 4), may be received in SIB13 as indicated above. The shortest modification period may equal the value of mcch-ModificationPeriod which may be received in the MBSFN-AreaInfoList IE.

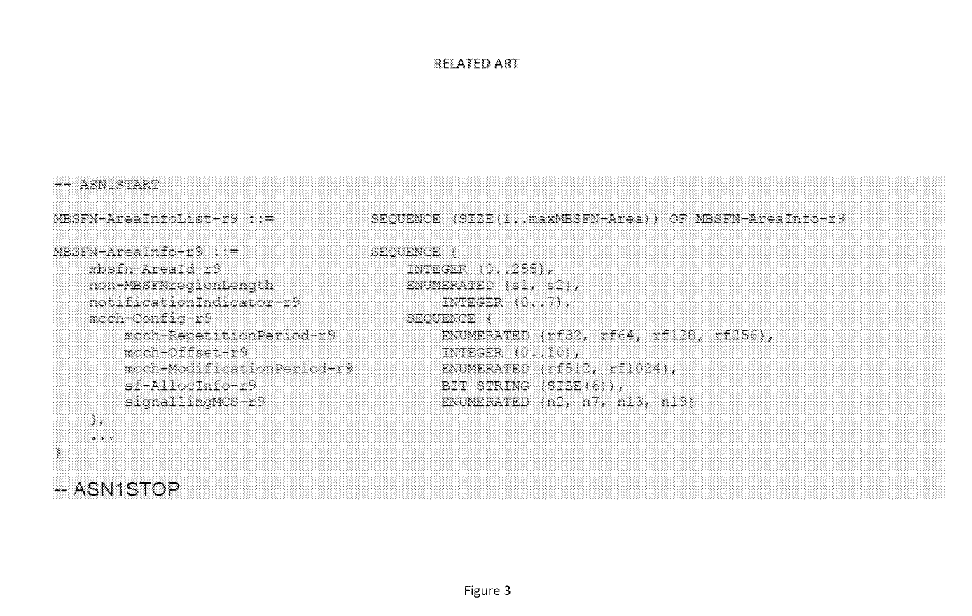

FIG. 3 illustrates an MBSFN-AreaInfoList IE. As may be seen from FIG. 3, mcch-ModificationPeriod may have values of (rf512, rf1024). Thus, the following change notification repetition periods are possible: [128; 256; 512; 1024].

3GPP TS 36.331 also describes the MCCH monitoring requirements for UEs receiving an MBMS service as well as UEs interested in receiving other services not yet started in another MBMS area. It indicates that a UE that is receiving an MBMS service may acquire the MCCH information from the start of each modification period. A UE that is not receiving an MBMS service, as well as UEs that are receiving an MBMS service but potentially interested to receive other services not started yet in another MBSFN area, may verify that the stored MCCH information remains valid by attempting to find the MCCH information change notification at least notificationRepetitionCoeff times during the modification period of the applicable MCCH(s), if no MCCH information change notification is received.

Moreover, 3GPP TS 36.331 indicates that, in case the UE is aware which MCCH(s) E-UTRAN uses for the service(s) it is interested to receive, the UE may only need to monitor change notifications for a subset of the MCCHs that are configured, which are referred to as the ‘applicable MCCH(s)’ above.

Thus, the following two are possible requirements. First, a UE that is receiving an MBMS service may acquire the MCCH information from the start of each modification period. Second, a UE that is not receiving an MBMS service, as well as UEs that are receiving an MBMS service but potentially interested to receive other services not started yet in another MBSFN area, may verify that the stored MCCH information remains valid by attempting to find the MCCH information change notification at least notificationRepetitionCoeff times during the modification period of the applicable MCCH(s), if no MCCH information change notification is received. Moreover, the UE may only need to monitor change notifications for a subset of the MCCHs.

Thus, when a UE is receiving the MBMS, the UE may receive MCCH information each MCCH repetition period. This may be beneficial because for MBMS user data, which is carried by the MTCH logical channel, E-UTRAN may periodically provide MCH scheduling information (MSI) at lower layers (MAC). This MCH information may only concern the time domain scheduling, while the frequency domain scheduling and the lower layer configuration may be semi-statically configured. The periodicity of the MSI may be configurable and defined by the MCH scheduling period.

Accordingly, minimum monitoring according to MCCH reception period may be configured in MBSFN-AreaInfoList IE, with mcch-RepetitionPeriod-r9 having contents of ENUMERATED {rf32, rf64, rf128, rf256}, which equals 320 ms, 640 ms, 1280 ms and 2560 ms.

When the UE is not receiving MBMS data, the UE may monitor the MCCH information according to the MCCH change notification, for example, as follows: P_{cnr}=Pₛₘ/Cₙᵣ, where P_{cnr} refers to a change notification repetition period, Pₛₘ refers to a shortest modification period, and Cₙᵣ refers to notificationRepetitionCoeff. Thus, the change notification repetition period may be [128; 256; 512; 1024], which equals 128 ms, 256 ms, 512 ms and 1024 ms.

Accordingly, there may be a difference between minimum MCCH monitoring depending on whether a UE is receiving MBMS data or not receiving MBMS data. For example, the requirements may be stricter for a UE not receiving MBMS data. Therefore, those monitoring requirements may or may not be enough for forming the basis of defining the UE minimum performance requirements for MBSFN measurements.

The MBSFN measurement minimum performance requirements may be based on the MBMS notification configuration parameters and the rules for monitoring the MBMS MCCH. Moreover, the MBSFN measurement minimum performance requirements may optionally be based solely on one set of monitoring requirements, namely on not receiving MBMS data. Alternatively, the requirements may be split in sets of requirements, such as a set for receiving MBMS data and a set for not receiving MBMS data.

The E-UTRAN connected mode may already have a sufficiently defined set of minimum requirements for measurement defined for infrequent measurement. As there already exists measurement requirements for connected mode DRX covering similar DRX intervals, such as 128, 256, 512 and 1024, certain embodiments may use those requirements for minimum performance requirements also for MBSFN measurements. The mapping of the MBMS configuration as described above to connected mode DRX cycle may be done as above. Thus, the MBMS configuration may map to connected mode DRX measurement requirements or similar, which may then enable straightforward definition of the requirements.

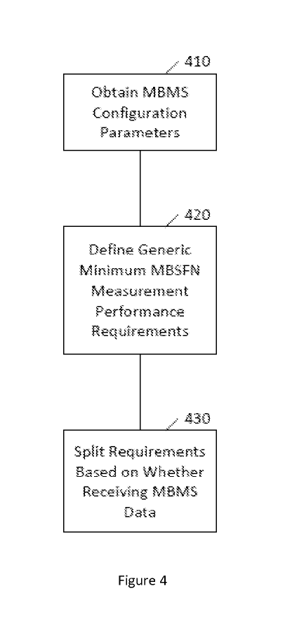

FIG. 4 illustrates a method according to certain embodiments. As shown in FIG. 4, at 410 a method may include obtaining MBMS configuration parameters. The method may also include, at 420, defining generic minimum MBSFN measurement performance requirements, based on the MBMS configuration parameters.

Definition of the generic minimum MBSFN measurement performance requirements may further be based on rules for monitoring the MBMS MCCH. For example, the definition may be based on a change notification repetition period, wherein the change notification repetition period is equal to a shortest modification period divided by a notification repetition coefficient.

Definition of generic minimum MBSFN measurement performance requirements may be split, at 430, with respect to whether receiving MBMS data or not receiving MBMS data. For example, when receiving MBMS data, the generic minimum MBSFN measurement performance requirements may be based on a configured MCCH reception period. On the other hand, when not receiving MBMS data, the generic minimum MBSFN measurement performance requirements may be based on an MCCH change notification repetition period, wherein the change notification repetition period is equal to a shortest modification period divided by a notification repetition coefficient.

Definition of the generic minimum MBSFN measurement performance requirements may include deriving which minimum requirements are to be applied according to discontinuous reception measurement requirements.

FIG. 5 illustrates a system according to certain embodiments of the invention. It should be understood that each block of the flowchart of FIG. 4, and any combination thereof, may be implemented by various means or their combinations, such as hardware, software, firmware, one or more processors and/or circuitry. In one embodiment, a system may include several devices, such as, for example, network element 510 and user equipment (UE) or user device 520. The system may include more than one UE 520 and more than one network element 510, although only one of each is shown for the purposes of illustration. A network element may be an access point, a base station, an eNode B (eNB), server, host or any of the other network elements discussed herein. Each of these devices may include at least one processor or control unit or module, respectively indicated as 514 and 524. At least one memory may be provided in each device, and indicated as 515 and 525, respectively. The memory may include computer program instructions or computer code contained therein. One or more transceiver 516 and 526 may be provided, and each device may also include an antenna, respectively illustrated as 517 and 527. Although only one antenna each is shown, many antennas and multiple antenna elements may be provided to each of the devices. Other configurations of these devices, for example, may be provided. For example, network element 510 and UE 520 may be additionally configured for wired communication, in addition to wireless communication, and in such a case antennas 517 and 527 may illustrate any form of communication hardware, without being limited to merely an antenna. Likewise, some network element 510 may be solely configured for wired communication, and such cases antenna 517 may illustrate any form of wired communication hardware, such as a network interface card.

Transceivers 516 and 526 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is as software that may run on a server.

A user device or user equipment 520 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof The user device or user equipment 520 may be a sensor or smart meter, or other device that may usually be configured for a single location.

In an exemplary embodiment, an apparatus, such as a node or user device, may include means for carrying out embodiments described above in relation to FIG. 4.

Processors 514 and 524 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof The processors may be implemented as a single controller, or a plurality of controllers or processors. Additionally, the processors may be implemented as a pool of processors in a local configuration, in a cloud configuration, or in a combination thereof.

For firmware or software, the implementation may include modules or unit of at least one chip set (e.g., procedures, functions, and so on). Memories 515 and 525 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors may be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 510 and/or UE 520, to perform any of the processes described above (see, for example, FIG. 4). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 5 illustrates a system including a network element 510 and a UE 520, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may ensure that measurements requirements are based on requirements for the UE monitoring. Additionally, certain embodiments may ensure that a UE is not required to wake up only to perform measurements. Furthermore, certain embodiments may ensure a direct mapping between the MBMS configuration and the performance requirements.

Moreover, certain embodiments may cover any MBMS configuration, and thereby be generic. Also, certain embodiments may be based on real MBMS monitoring requirements and may map to already existing requirements. Further, certain embodiments may ensure fast requirement work, if—for example—connected mode DRX requirements are used.

Additionally, certain embodiments may be supported even if two sets of requirements are decided, such as one set for receiving and another for not receiving MBMS data. Moreover, no extra wake up may be needed on UE side, and no new parameters may be needed.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

Partial Glossary

MBMS multimedia broadcast multimedia service

MBSFN MBMS single frequency network

RSRP reference signal received power

RSRQ reference signal received quality

DRX discontinuous reception

MCCH MBMS control channel

MTCH MBMS traffic channel

RNTI Radio Network Temporary Identifier

PDCCH physical downlink control channel

1-20. (canceled)

21. A method, comprising:
obtaining multimedia broadcast multimedia service (MBMS) configuration parameters;
defining generic minimum MBMS single frequency network (MBSFN) measurement performance requirements, based on the MBMS configuration parameters; and
performing MBMS measurements in accordance with the defined generic minimum MBSFN measurement performance requirements.

22. The method of claim 21, wherein defining the generic minimum MBSFN measurement performance requirements is further based on rules for monitoring the MBMS control channel.

23. The method of claim 21, wherein defining the generic minimum MBSFN measurement performance requirements is further based on a change notification repetition period, wherein the change notification repetition period is equal to a shortest modification period divided by a notification repetition coefficient.

24. The method of claim 21, wherein defining the generic minimum MBSFN measurement performance requirements is split with respect to whether receiving MBMS data or not receiving MBMS data.

25. The method of claim 21, wherein, for receiving MBMS data, defining the generic minimum MBSFN measurement performance requirements is further based on a configured MBMS control channel reception period.

26. The method of claim 21, wherein, for not receiving MBMS data, defining the generic minimum MBSFN measurement performance requirements is further based on an MBMS control channel change notification repetition period.

27. The method of claim 26, wherein the change notification repetition period is equal to a shortest modification period divided by a notification repetition coefficient.

28. The method of claim 21, wherein defining the generic minimum MBSFN measurement performance requirements comprises deriving which minimum requirements are to be applied according to discontinuous reception measurement requirements.

29. An apparatus, comprising:
at least one processor; and
at least one memory including computer program code,
wherein the at least one memory and the computer program code are configured to, with the at least one processor, cause the apparatus at least to
obtain MBMS configuration parameters;
define generic minimum MBSFN measurement performance requirements, based on the MBMS configuration parameters; and
perform MBMS measurements in accordance with the defined generic minimum MBSFN measurement performance requirements.

30. The apparatus of claim 29, wherein definition of the generic minimum MBSFN measurement performance requirements is further based on rules for monitoring the MBMS control channel.

31. The apparatus of claim 29, wherein definition of the generic minimum MBSFN measurement performance requirements is further based on a change notification repetition period, wherein the change notification repetition period is equal to a shortest modification period divided by a notification repetition coefficient.

32. The apparatus of claim 29, wherein definition of the generic minimum MBSFN measurement performance requirements is split with respect to whether receiving MBMS data or not receiving MBMS data.

33. The apparatus of claim 29, wherein, for receiving MBMS data, definition of the generic minimum MBSFN measurement performance requirements is based on a configured MBMS control channel reception period.

34. The apparatus of claim 29, wherein, for not receiving MBMS data, definition of the generic minimum MBSFN measurement performance requirements is based on an MBMS control channel change notification repetition period.

35. The apparatus of claim 34, wherein the change notification repetition period is equal to a shortest modification period divided by a notification repetition coefficient.

36. The apparatus of claim 29, wherein definition of the generic minimum MBSFN measurement performance requirements comprises deriving which minimum requirements are to be applied according to discontinuous reception measurement requirements.

37. A non-transitory computer program product encoding instructions for performing a process, the process comprising:
obtaining multimedia broadcast multimedia service (MBMS) configuration parameters;
defining generic minimum MBMS single frequency network (MBSFN) measurement performance requirements, based on the MBMS configuration parameters; and
performing MBMS measurements in accordance with the defined generic minimum MBSFN measurement performance requirements.

38. The computer program product of claim 37, wherein defining the generic minimum MBSFN measurement performance requirements is further based on rules for monitoring the MBMS control channel.

39. The computer program product of claim 37, wherein defining the generic minimum MBSFN measurement performance requirements is further based on a change notification repetition period, wherein the change notification repetition period is equal to a shortest modification period divided by a notification repetition coefficient.

40. The computer program product of claim 37, wherein, for not receiving MBMS data, defining the generic minimum MBSFN measurement performance requirements is further based on an MBMS control channel change notification repetition period.
